(19) United States
(12) Patent Application Publication
(10) Pub. No.: US 2018/0127029 A1
(43) Pub. Date: May 10, 2018

(54) VEHICLE STRUCTURE

(71) Applicant: TOYOTA JIDOSHA KABUSHIKI KAISHA, Toyota-shi (JP)

(72) Inventors: Yukinobu NISHIKAWA, Anjo-shi (JP); Hiroaki KIYOKAMI, Toyota-shi (JP); Yota MIZUNO, Nisshin-shi (JP)

(73) Assignee: TOYOTA JIDOSHA KABUSHIKI KAISHA, Toyota-shi (JP)

(21) Appl. No.: 15/795,963

(22) Filed: Oct. 27, 2017

(30) Foreign Application Priority Data
Nov. 4, 2016 (JP) 2016-216553

(51) Int. Cl. B62D 21/15; B62D 25/08

(52) U.S. Cl. CPC B62D 21/152; B60R 16/0215; B60Y 2200/92; B62D 25/082

(57) ABSTRACT

A vehicle structure includes a pair of right and left front side members, a rotary electric machine, a casing disposed in close proximity to one front side member, a cover closing an opening portion of the casing, and a connector attached to a part of the cover that is the closest to a flange portion. The casing includes the opening portion facing the one front side member side and a thick portion surrounding the opening portion. The cover includes the flange portion overlapping with the thick portion of the casing in close contact with the thick portion of the casing. The connector is disposed at a position where the one front side member is deformed and pressed when the one front side member is subjected to a load equivalent to a load applied in a small overlap collision test or an oblique collision test.

### INCORPORATION BY REFERENCE

The disclosure of Japanese Patent Application No. 2016-216553 filed on Nov. 4, 2016 including the specification, drawings and abstract is incorporated herein by reference in its entirety.

### BACKGROUND

### 1. Technical Field

The present disclosure relates to a vehicle structure that is capable of ensuring safety with respect to a small overlap collision and an oblique collision of a vehicle.

### 2. Description of Related Art

Vehicles need to meet safety standards based on predetermined collision tests so that occupants are protected from vehicle collision accidents. Various collision tests for vehicle collision safety assessment have been prescribed or proposed in various countries and test results regarding some globally major vehicles have been published in some of the countries.

At present, small overlap and oblique collision tests are regarded as two of the toughest collision tests regarding vehicle collision safety. The small overlap collision test assumes a collision with a thin object such as a tree and a utility pole. The oblique collision test assumes an oblique collision. To be more specific, the small overlap collision test is a test method by which 25% of the width of a vehicle collides with a fixed barrier at 64 km per hour. The oblique collision test is a test method by which a collision occurs in a state where a collision surface of a fixed barrier is at a predetermined angle (such as 30 degrees) to the direction in which a vehicle is driven.

In a case where the small overlap collision test and the oblique collision test described above are performed on a vehicle that has a vehicle structure according to the related art, a front side member of the vehicle is hard to collapse and a large impact folding the front side member is applied. Accordingly, collision energy is rarely absorbed.

In this regard, a vehicle structure for transmitting a collision load to a power unit accommodated in an engine compartment and dispersing the collision load during a collision is disclosed in, for example, Japanese Unexamined Patent Application Publication No. 2016-037242 (JP 2016-037242 A). More specifically, the collision load is dispersed to the power unit by the front side member being bent by the collision load and the front side member being pressed against the side portion of the power unit.

### SUMMARY

When it comes to a so-called hybrid vehicle that has a combination of an internal combustion engine and a rotary electric machine as its electric motor and an electric car traveling based solely on a rotary electric machine, a secondary battery such as a lithium ion secondary battery is used as an electric power source for driving the rotary electric machine. The electric power from the secondary battery is supplied to the rotary electric machine via a high voltage electric power cable and high voltage components such as the high voltage electric power cable and the rotary electric machine are accommodated in a casing. Also accommodated in the casing is a sensor configured to acquire information related to the rotary electric machine such as the rotation speed of a rotor shaft and the information is taken to the outside of the casing. In addition, a cover closing an opening portion of the casing is coupled with the casing.

In the hybrid vehicle and the electric car described above, a high voltage current flows through the high voltage components. Accordingly, safety needs to be ensured in terms of voltage and current.

In a case where the small overlap collision test and the oblique collision test are performed with the vehicle structure disclosed in JP 2016-037242 A applied to the hybrid vehicle and the electric car, a large collision load is applied to the side portion of the power unit, that is, the cover. In most cases, the cover is made of an aluminum alloy that can be easily formed into complex shapes. Accordingly, the cover cannot endure, depending on its structure, the collision load from the front side member made up of a high-tensile steel material. As a result, cracking occurs in the cover and safety against the high voltage current is impaired. Then, US regulations such as FMVSS305 cannot be complied with.

The present disclosure provides a vehicle structure for a hybrid vehicle and an electric car that is capable of preventing a cover from cracking during a small overlap or oblique collision test for the vehicle and ensuring safety with respect to a small overlap or oblique collision.

An aspect of the present disclosure relates to a vehicle structure including a pair of right and left front side members, each extending along a front-rear direction of a front portion of a vehicle, a rotary electric machine, a casing disposed in close proximity to one front side member of the pair of right and left front side members, a cover closing an opening portion of the casing, and a connector attached to a part of the cover that is the closest to a flange portion. The one front member is deformed and pressed when the one front side member is subjected to a load equivalent to a load applied in a small overlap collision test or an oblique collision test. The casing is configured to accommodate a sensor configured to acquire information related to the rotary electric machine and a signal cable connected to the sensor. The casing includes the opening portion facing the one front side member side and a thick portion surrounding the opening portion. The cover includes the flange portion overlapping with the thick portion of the casing in close contact with the thick portion of the casing. The connector is configured to be connected to a wire harness outside the cover and connected to the signal cable inside the cover. The connector is disposed at a position where the one front side member is deformed and pressed when the one front side member is subjected to a load equivalent to a load applied in a small overlap collision test or an oblique collision test.

According to the aspect of the present disclosure, the front side member is deformed and pressed against the connector part during the small overlap collision test or the oblique collision test. The connector to which the wire harness and the signal cable are connected is higher in strength than the parts of the cover other than the flange portion. In addition, the connector higher in strength is attached to the part of the cover that is the closest to the flange portion. Accordingly, a collision load from the front side member is transmitted from the connector to the cover and casing side without cracking of the cover.

According to the aspect of the present disclosure, the connector is used as a member subjected to the collision load during the small overlap collision test or the oblique collision test. Accordingly, cracking of the cover can be prevented without an increase in the number of components. Accordingly, a vehicle structure can be provided that ensures safety with respect to a high voltage current during a small overlap collision or an oblique collision.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is an isometric drawing schematically illustrating the structure of the front portion of a vehicle according to an embodiment in which a vehicle structure according to the present disclosure is applied to a hybrid vehicle;

FIG. 2 is a side view of a casing and cover parts of the embodiment illustrated in FIG. 1;

FIG. 3 is a sectional view along the III-III arrow view in FIG. 2;

FIG. 4 is a plan view schematically illustrating the vehicle structure according to the embodiment illustrated in FIG. 1; and

FIG. 5 is a sectional view along the V-V arrow view in FIG. 4 and schematically illustrates the state of a front side member deformed as a result of a small overlap collision test.

### DETAILED DESCRIPTION OF EMBODIMENTS

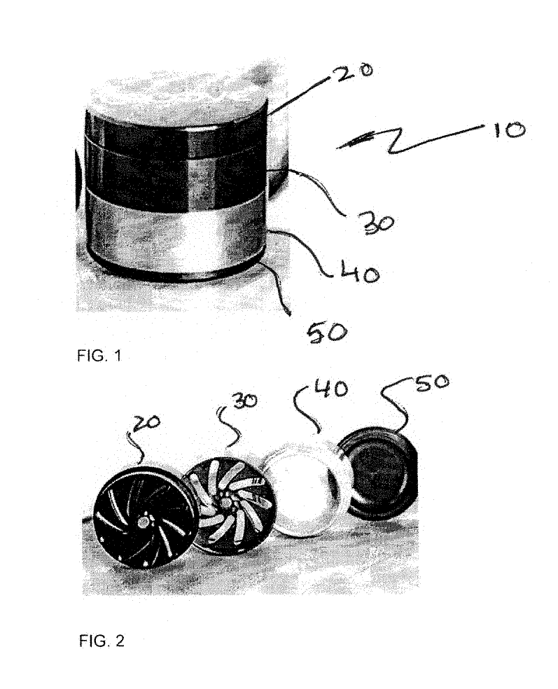

Hereinafter, an embodiment in which a vehicle structure according to the present disclosure is applied to a hybrid vehicle will be described in detail with reference to FIGS. 1 to 5. However, an applicable embodiment of the present disclosure is not limited to the embodiment above. The present disclosure is applicable with respect to any vehicle insofar as a casing accommodating a rotary electric machine and a high voltage electric power cable is mounted in the front of the vehicle.

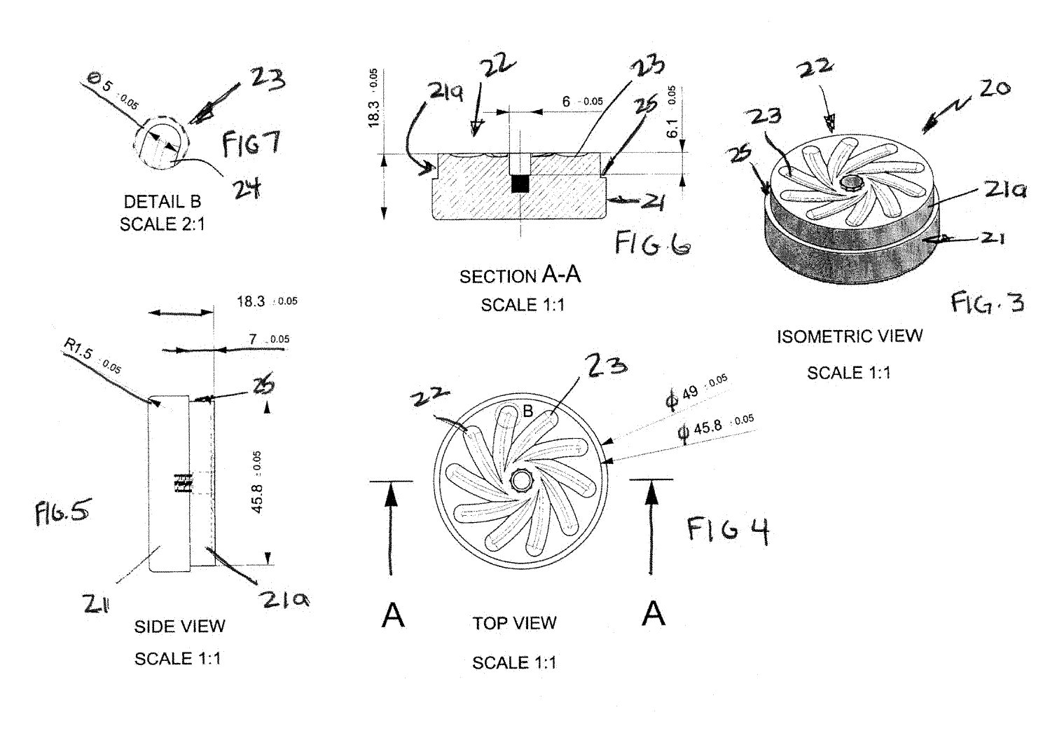

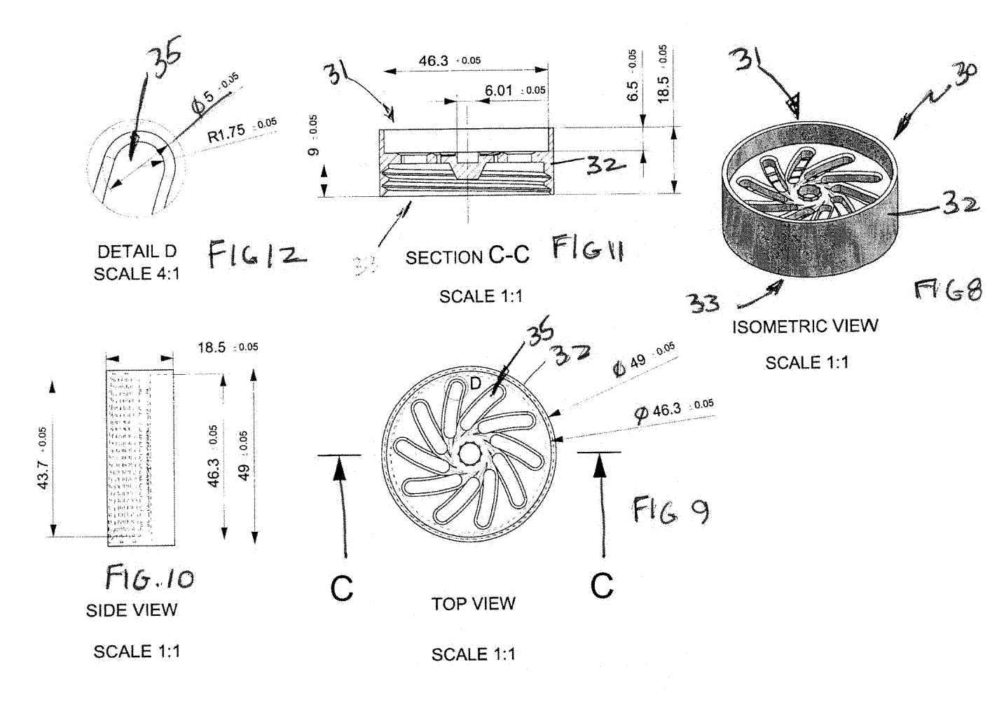

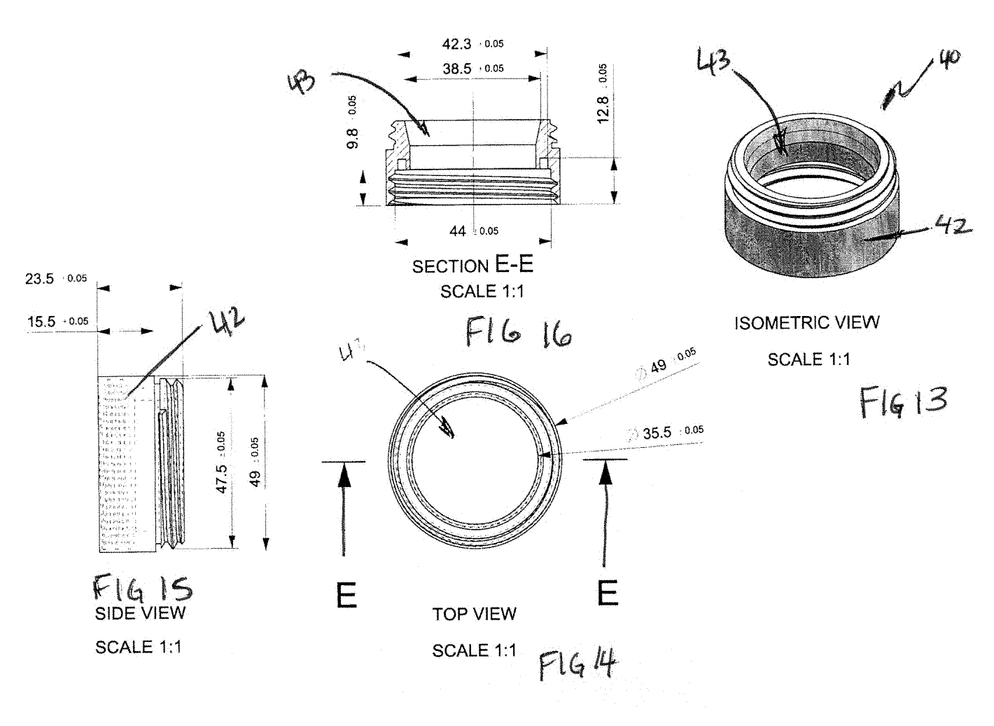

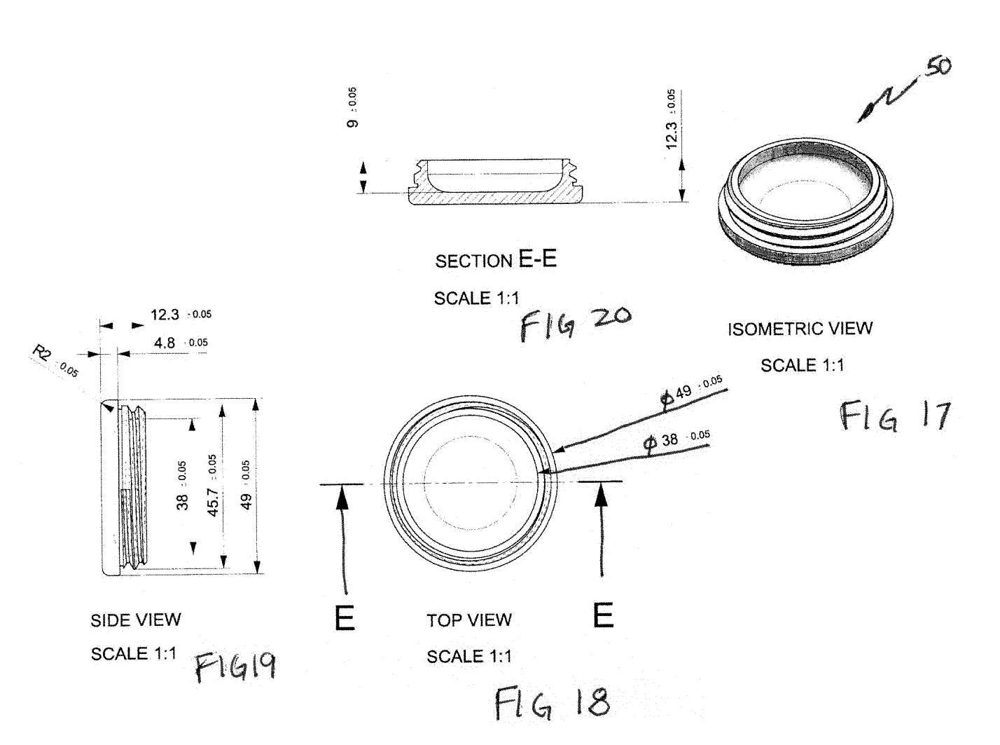

FIG. 1 schematically illustrates the internal structure of the front portion of the hybrid vehicle according to the embodiment. The side-view shape of the transaxle case in FIG. 1 is illustrated in FIG. 2. A sectional structure along the III-III arrow view in FIG. 2 is illustrated in FIG. 3. The plan-view shape of the vehicle structure in the front portion of the vehicle according to the embodiment is schematically illustrated in FIG. 4. A front-view shape along the V-V arrow view in FIG. 4 is illustrated in FIG. 5. The hybrid vehicle according to the embodiment is a front-engine front-drive (FF) vehicle in which an internal combustion engine, that is, an engine 10, a rotary electric machine 11 (refer to FIG. 5), and a power transmission mechanism (not illustrated) are arranged side by side. However, the hybrid vehicle according to the embodiment is not limited to the FF vehicle.

The front end portions of a pair of right and left front side members 12R, 12L, each extending along the front-rear direction of the front portion of the vehicle are respectively connected to the right and left side end portions of a front cross member 13. The rear end portions of the front side members 12R, 12L are connected to a floor side member (not illustrated) through the lower portion of a dash panel partitioning the engine compartment of the vehicle and the occupant compartment (cabin) of the vehicle from each other, that is, a toe board 14. However, an applicable embodiment of the present disclosure is not limited thereto.

Structurally, the front side member 12L are bent in a bellows shape and are capable of absorbing a part of a collision load during a small overlap collision test or an oblique collision test. More specifically, the front side members 12R, 12L according to the embodiment have a front end portion 121, a front side oblique portion 122, a rear side oblique portion 123, and a rear portion 124 in this order toward the rear end side from the front ends of the front side members 12R, 12L. Bent portions 125 to 127 are formed between the front end portion 121 and the front side oblique portion 122, between the front side oblique portion 122 and the rear side oblique portion 123, and between the rear side oblique portion 123 and the rear portion 124, respectively. The front end portion 121 and the rear portion 124 extend substantially in a straight line and in parallel to the front-rear direction of the front portion of the vehicle. The front side oblique portion 122 is bent to the inner side in the width direction of the vehicle from the front end portion 121 toward the rear side oblique portion 123. The rear side oblique portion 123 is bent to the outer side in the width direction of the vehicle from the front side oblique portion 122 toward the rear portion 124. Accordingly, in a case where the small overlap collision test or the oblique collision test is performed, the entire part of each of the bent portions 125 to 127 is bent to an even larger extent. As a result, the front side oblique portion 122 and the rear side oblique portion 123 overlap with each other and are deformed such that the front end portion 121 and the rear portion 124 approach each other.

In FIG. 4, the front side members 12R, 12L in their state preceding the collision test are drawn with solid lines and the front side members 12R, 12L in their state following the collision test are drawn with two-dot chain lines. In FIG. 5, the front side members 12R, 12L in their state following the collision test are drawn with solid lines and the front side members 12R, 12L in their state preceding the collision test are drawn with two-dot chain lines.

The engine 10, the rotary electric machine 11, and the power transmission mechanism are mounted as power units in the engine compartment. The output of the engine 10 and the output of the rotary electric machine 11 are transmitted via the power transmission mechanism to right and left front wheels, that is, drive wheels 15R, 15L. The rotary electric machine 11 and the power transmission mechanism are accommodated in a transaxle case 16. The transaxle case 16 and the engine 10 remains supported by the vehicle via a bracket (not illustrated).

A housing 17, a casing 18, and a cover 19 constitute the main portion of the transaxle case 16 according to the embodiment. The housing 17, the casing 18, the cover 19, and the engine 10 are arranged in the width direction of the vehicle. In other words, the housing 17 is arranged adjacent to the engine 10. The casing 18 is across the housing 17 from the engine 10. The cover 19 is across the housing 17 and the casing 18 from the engine 10. However, an applicable embodiment of the present disclosure is not limited thereto. The power transmission mechanism is accommodated in the housing 17. The power transmission mechanism is connected to a crankshaft (not illustrated) of the engine 10 and a rotor shaft (not illustrated) of the rotary electric machine 11. The casing 18 accommodates the rotary electric machine 11, an electric power cable (not illustrated) connected to the rotary electric machine 11, a sensor (not illustrated) for acquiring information related to the rotary electric machine 11 such as the rotation speed of the rotor shaft, and a signal cable 20 connected to the sensor. The casing 18 is arranged in close proximity to the front side member 12L. The front side member 12L (hereinafter, referred to as the left front side member) is on the side deformed more than other front side member 12R when the left front side member 12L is subjected to a load equivalent to a load applied in a small overlap collision test or an oblique collision test (left side of the vehicle in the illustrated example). In other words, the engine 10 is arranged in close proximity to the other front side member 12R on the side not deformed as much as the left front side member 12L during the small overlap collision test or the oblique collision test (right side of the vehicle in the illustrated example). The casing 18 has an opening portion (not illustrated) facing the left front side member 12L side deformed more than other front side member 12R during the small overlap collision test or the oblique collision test and a thick portion 181 surrounding the opening portion.

The cover 19 closes the opening portion of the casing 18. The cover 19 has a flange portion 191. The flange portion 191 overlaps with the thick portion 181 of the casing 18 in close contact with the thick portion 181 of the casing 18. The casing 18 and the cover 19 are integrally coupled with each other by a plurality of fastening members with the thick portion 181 and the flange portion 191 overlapping with each other. In the embodiment, the fastening members are a plurality of bolts 21.

A wire harness 22 is connected to the cover 19 from the outside. Specifically, the wire harness 22 is connected to the closest to the flange portion 191 of the cover 19 that is relatively higher in strength than the ordinary portion of the cover 19 that does not include the flange portion 191. A receptacle 23 to which the signal cable 20 is connected inside the cover 19 is attached as a connector according to the present disclosure.

The receptacle 23 attached to the cover 19 and the left front side member 12L have relative positions set as follows. The bent portion 127 between the rear portion 124 and the rear side oblique portion 123 of the left front side member 12L is positioned just beside the receptacle 23. In addition, a part of the rear side oblique portion 123 is positioned in front of the casing 18 and the cover 19 such that the part of the rear side oblique portion 123 of the left front side member 12L (on the front side of the vehicle) overlaps with the cover 19 and the casing 18 of the transaxle case 16 in the front-rear direction of the front portion of the vehicle.

As a result, the part of the rear side oblique portion 123 of the left front side member 12L deformed during the small overlap collision test or the oblique collision test can be reliably pressed against the receptacle 23 of the cover 19. The vicinity of the receptacle 23 attached to the cover 19 becomes a region higher in strength than the other parts because of the flange portion 191. Accordingly, cracking attributable to the collision load does not occur in the cover 19 and the collision load can be diffused to the casing 18 side. In other words, the left front side member 12L can be prevented from being pressed against the ordinary portion of the cover 19 relatively low in strength by a reliable collision between the receptacle 23 and the left front side member 12L deformed during the collision test described above. It can be said that it is even more preferable that the bolts 21 are arranged in the vicinity of the attachment position of the receptacle 23 from the viewpoint of increasing the strength of the part of the cover 19 in the vicinity of the attachment position of the receptacle 23.

In a case where at least one fastening member is disposed in the vicinity of the connector, the collision load can be transmitted from the connector to the cover and the casing via the fastening member. As a result, cracking of the cover can be further prevented.

The embodiments of the present disclosure should be interpreted based solely on the scope of claims. Any change or modification included in the concept of the present disclosure can be added to the description of the embodiment described above. In other words, every matter according to the embodiment described above does not limit an applicable embodiment of the present disclosure and every matter according to the embodiment including configurations not directly related to the present disclosure can be appropriately changed depending on purpose and application.

What is claimed is:

1. A vehicle structure comprising:
a pair of right and left front side members, each extending along a front-rear direction of a front portion of a vehicle;
a rotary electric machine;
a casing disposed in close proximity to one front side member of the pair of right and left front side members, the one front side member being deformed and pressed when the one front side member is subjected to a load equivalent to a load applied in a small overlap collision test or an oblique collision test, the casing being configured to accommodate a sensor configured to acquire information related to the rotary electric machine and a signal cable connected to the sensor and the casing including an opening portion facing the one front side member side and a thick portion surrounding the opening portion;
a cover closing the opening portion of the casing, the cover including a flange portion overlapping with the thick portion of the casing in close contact with the thick portion of the casing; and
a connector attached to a part of the cover that is the closest to the flange portion, the connector being configured to be connected to a wire harness outside the cover and connected to the signal cable inside the cover and the connector being disposed at a position where the one front side member is deformed and pressed when the one front side member is subjected to a load equivalent to a load applied in a small overlap collision test or an oblique collision test.

2. The vehicle structure according to claim 1, further comprising a plurality of fastening members integrally coupling the casing and the cover with each other with the thick portion of the casing and the flange portion of the cover overlapping with each other,
wherein at least one of the fastening members is disposed in a vicinity of the connector.
